(19) United States
(12) Patent Application Publication
(10) Pub. No.: US 2013/0236677 A1
(43) Pub. Date: Sep. 12, 2013

(54) DETECTOR AND METHOD OF PANEL BONDING USING REMOVABLE ADHESIVE FILM

(71) Applicants: Liang Zhang, Beijing (CN); Hongye Zhang, Beijing (CN); Nicholas Konkle, Waukesha, WI (US)

(72) Inventors: Liang Zhang, Beijing (CN); Hongye Zhang, Beijing (CN); Nicholas Konkle, Waukesha, WI (US)

(73) Assignee: GE MEDICAL SYSTEMS GLOBAL TECHNOLOGY COMPANY, LLC, Waukesha, WI (US)

(21) Appl. No.: 13/413,589

(22) Filed: Mar. 6, 2012

(51) Int. Cl. B32B 7/06

(52) U.S. Cl. 428/61; 156/306.6; 156/247; 156/280; 428/411.1; 428/192; 428/332; 428/222

(57) ABSTRACT

A method of manufacturing a detector is provided. The method includes using a removable double-faced adhesive film to bond a flat panel detector and a panel detector support.

### BACKGROUND OF THE INVENTION

The present invention relates to a method of manufacturing a detector, in particular to a method of manufacturing a flat panel detector of a medical imaging diagnostic device.

The flat panel detector is an important component of an X-ray detector and is relatively expensive. During assembling, bad pixels usually appear in the flat panel detector due to Electrostatic Discharge (ESD), and the performance of the flat panel detector also degrades during the use thereof. Such flat panel detectors can be repaired with a laser. Replacement and repair of the flat panel detector, namely, using a reusable flat panel detector, can save on the production cost of the X-ray detector. There are two ways available at present for bonding the flat panel detector. One method of making the flat panel detector reusable is adhering the four sides of the flat panel detector to the panel detector support using the Room Temperature Vulcanized Silicone Rubber (which is referred to as “the RTV adhering method” for short). The problem with this method is that the RTV at the edge of the flat panel detector and the foam under the flat panel detector make the edge and the middle part of the flat panel detector have different a strength and stiffness, resulting in non-uniform weight distribution on the surface of the flat panel detector, thus making the flat panel detector very fragile. Another method is bonding the entire surface of the flat panel detector on the panel detector support (which is referred to as the “entire surface bonding method”), but the flat panel detector bonded in this way cannot be reused once it is damaged.

U.S. Pat. Nos. 7,396,159, 7,244,945, and 6,847,041 each disclose some ways of bonding the flat panel detector on the panel detector support.

### BRIEF DESCRIPTION OF THE INVENTION

With respect to the above problem, in one aspect, a method of manufacturing a detector is provided. The method includes bonding the flat panel detector and the panel detector support using a removable double-faced adhesive film.

In one embodiment, the removable double-faced adhesive film is adhered between the planes of the flat panel detector and the panel detector support and is removed immediately after the adhering, or is removed after a period of time.

The adhesive film is removed by pulling forcibly the end thereof, and the pulling may be performing using tools or control methods.

In one embodiment, the removable double-faced adhesive film is adhered to the four sides of the flat panel detector.

In one embodiment, the removable double-faced adhesive film is adhered to the entire surface of the flat panel detector.

In one embodiment, the removable double-faced adhesive film is arranged to be diverging from the center of the flat panel detector to its surroundings, and ends of the adhesive films are left at outside of the surface of the flat panel detector, so that the adhesive films are removed by pulling the ends thereof.

In one embodiment, the removable double-faced adhesive film is in a strip spiral arrangement.

In one embodiment, the removable double-faced adhesive film is arranged in such a way that the surface of the flat panel detector is divided into four triangular areas by two crossing diagonals, the strip adhesive films connecting end to end in succession in each area.

In one embodiment, the removable double-faced adhesive film is an optical adhesive film with a thickness of 100-200 microns.

In one embodiment, a layer of black glass priming paint is added at the backside of the flat panel detector.

The embodiments described herein utilize a removable double-faced adhesive film to bond the flat panel detector, so that the flat panel detector can be easily removed after being bonded. The assembly method described herein has both the advantages of high firmness and reliability as in the original entire surface bonding method, and overcomes the defect that the flat panel detector cannot be repaired or reused. By means of the assembling method described herein, the flat panel detector can be easily removed or repaired, thus greatly reducing the manufacturing cost. In addition, by means of the assembling method described herein, the weight distribution on the surface of the flat panel detector is uniform, and the panel detector support can more effectively support the flat panel detector, thereby improving the reliability of the flat panel detector.

### BRIEF DESCRIPTION OF THE DRAWINGS

FIG. 1 is a schematic diagram illustrating an RTV adhering method for a flat panel detector.

FIGS. 2A and 2B are schematic diagrams illustrating an exemplary method for manufacturing a detector;

FIGS. 3A and 3B are schematic diagrams of two arrangements of adhesive films that may be used with the method illustrated in FIG. 1;

FIG. 4 is a schematic diagram illustrating an exemplary method of adding a layer of black glass priming paint to reduce the scattered rays of the adhesive film that may be used with the method illustrated in FIG. 1.

### DETAILED DESCRIPTION OF THE INVENTION

Systems and methods will be described in further detail below through specific embodiments, but are not limited to the specific embodiments described herein.

The specific embodiments are described in detail below in conjunction with the drawings, but these embodiments are not intended to be limiting. The same components in different drawings are denoted by the same reference signs.

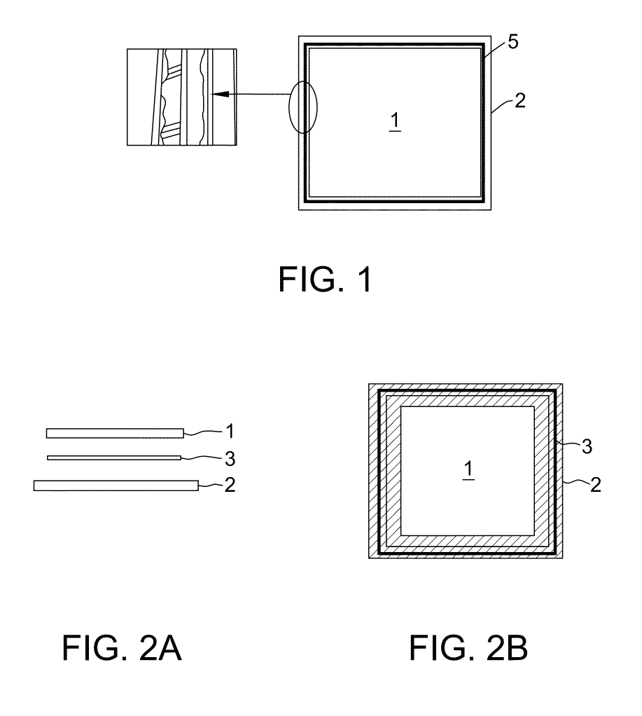

FIG. 1 is a schematic diagram illustrating an RTV adhering method for a flat panel detector.

FIG. 1 shows the principle of the original RTV adhering method, wherein the four sides of the flat panel detector 1 are adhered to the panel detector support 2 using RTV 5. Such a method results in a non-uniform distribution of weight on the surface of the flat panel detector 1, so the flat panel detector 1 is very fragile.

FIGS. 2A and 2B are schematic diagrams illustrating an exemplary method for manufacturing a detector, wherein the flat panel detector 1 is adhered to the panel detector support 2 through a new removable double-faced adhesive film 3. FIG. 2A shows the adhesive film 3 arranged between the flat panel detector and the panel detector support 2. The removable double-faced adhesive film 3, such as an optical adhesive film of 100-200 microns, is adhered between two rolling depression planes of the flat panel detector 1 and the panel detector support 2, and is removed immediately after being adhered or is removed after a period of time. The arrangement of the adhesive film 3 is designed in such a way that it is removed by pulling the end thereof forcibly or by pulling with tools or control methods. By means of such a method, the flat panel detector 1 can be easily removed. Further, the surface of the flat panel detector 1 has a uniform weight distribution, so it will not be easily damaged.

A plurality of possible arrangements of adhesive films may be used. For example, FIG. 2B shows one kind of adhesive film arrangement of adhering at the four sides of the flat panel detector 1.

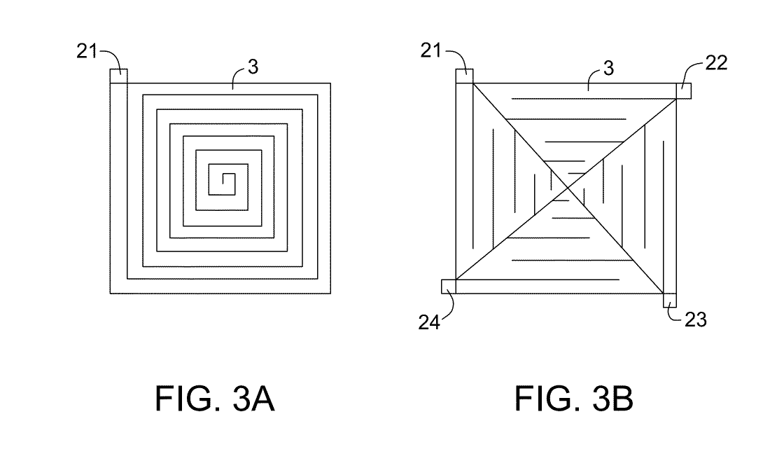

FIGS. 3A and 3B show two arrangements of strips of adhesive film 3 adhered to an entire surface of the flat panel detector 1.

In FIG. 3A, the strip of adhesive film 3 is in a spiral arrangement, which diverges from the center of the flat panel detector, with the end 21 of the strip of adhesive film 3 extending beyond the surface of the flat panel detector. After adhering the flat panel detector 1 to the panel detector support 2 through the adhesive film 3, the strip of adhesive film 3 is pulled. That is, the end 21 of the adhesive film 3 is pulled out forcibly. When arranging the adhesive film 3, the adhesive film 3 may be adhered to the panel detector support 2, and then spiral lines are cut on the surface of the adhesive film 3, or a sheet of the adhesive film 3 is pre-cut in this spiral manner.

In FIG. 3B, the surface of the flat panel detector 1 is divided into four triangular areas by two crossing diagonals, with strips of adhesive film 3 connecting end to end in succession in each area, and the ends 21, 22, 23 and 24 of the strips of adhesive film 3 extending beyond the surface of the flat panel detector 1. After adhering the flat panel detector 1 to the panel detector support 2 through the adhesive film 3, the strips in the four areas are each pulled. Specifically, the ends 21, 22, 23 and 24 of the strips of adhesive film 3 left outside of each area are pulled out forcibly. When arranging the adhesive film 3, the adhesive film 3 may be adhered to the panel detector support 2, then two diagonals are cut on the adhesive film 3, and then vertical and horizontal lines are further cut in the four triangular areas formed by two crossing diagonals, while leaving an end 21, 22, 23, 24 of each strip of adhesive film 3 outside of each area.

Both of the two entire surface adhering methods shown in FIGS. 3A and 3B involve pulling the adhesive film strips from the edges. Thus the arrangement of the adhesive film strips must be starting from the center and diverging to the edges to cover the entire surface area of the flat panel detector 1.

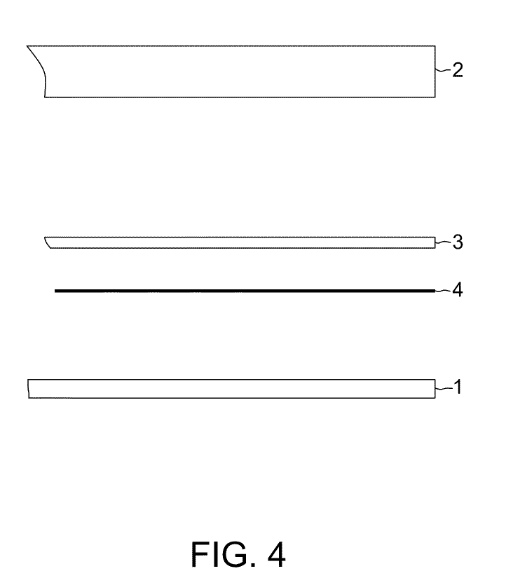

If the adhesive film arrangement is in a diverging shape and non-uniform, since the adhesive film 3 is in the light-transmissive area behind the flat panel detector 2, the air bubbles or edge imprints generated during the adhering process may appear in the images, and may lead the doctors to a misdiagnosis. Even if a gain calibration method is used during assembling of the flat panel detector 1, air bubbles or adhesive film edge imprints may still occur after a long time. FIG. 4 is a schematic diagram illustrating an assembling method of adding a layer of black glass priming paint 4 at a backside of the flat panel detector 1 for blocking the adhesive film air bubbles or the edge scattered rays. Specifically, the priming paint 4 is located between the flat panel detector and the adhesive film 3. Accordingly, the layers are flat panel detector 1, panel detector support 2, removable adhesive film 3, and black glass priming paint 4. The layer of black glass priming paint 4 can also help to improve the EDS reliability of the flat panel detector.

The manufacturing method of a detector as described herein can also be applied to manufacturing of other flat panel detectors (e.g. LCD) in addition to the manufacturing of the flat panel detector used for medical imaging diagnostic devices (e.g. X-ray imaging system, CT device).

The embodiments described above are only for illustration, and in no way limit the scope of the present invention. It shall be noted that those ordinarily skilled in the art will be able to make many improvements, modifications and variations to the present invention, and these improvements, modifications and variations, which are not departing from the spirit of the present invention, shall be considered as falling within the scope of the present application.

1. A method of manufacturing a detector, said method comprising using a removable double-faced adhesive film to bond a flat panel detector and a panel detector support.

2. The method of manufacturing a detector according to claim 1, wherein the removable double-faced adhesive film is adhered between planes of the flat panel detector and the panel detector support, and wherein said method further comprises removing the adhesive film immediately after the adhering or after a period of time.

3. The method of manufacturing a detector according to claim 2, wherein removing the adhesive film comprises forcibly pulling out an end of the adhesive film using tools or control methods.

4. The method of manufacturing a detector according to claim 3, wherein the removable double-faced adhesive film is adhered to four sides of the flat panel detector.

5. The method of manufacturing a detector according to claim 3, wherein the removable double-faced adhesive film is adhered to an entire surface of the flat panel detector.

6. The method of manufacturing a detector according to claim 5, wherein the removable double-faced adhesive film is arranged to diverge from a center of the flat panel detector to surroundings of the flat panel detector, and wherein the end of the adhesive film extends beyond the surface of the flat panel detector to facilitate removing the adhesive film by pulling the end of the adhesive film.

7. The method of manufacturing a detector according to claim 6, wherein the removable double-faced adhesive film is in a strip spiral arrangement.

8. The method of manufacturing a detector according to claim 6, wherein the removable double-faced adhesive film is arranged such that the surface of the panel detector is divided into four triangular areas by two crossing diagonals, and wherein strips of the adhesive film connect end to end in succession in each area.

9. The method of manufacturing a detector according to claim 1, wherein the removable double-faced adhesive film is an optical adhesive film with a thickness of 100-200 microns.

10. The method of manufacturing a detector according to claim 1, further comprising adding a layer of black glass priming paint at a backside of the flat panel detector.

11. A detector comprising:
a flat panel detector;
a panel detector support; and
a removable double-faced adhesive film bonding said flat panel detector to said panel detector support.

12. The detector according to claim 11, wherein said removable double-faced adhesive film is adhered between planes of said flat panel detector and said panel detector support, said adhesive film configured to be removed immediately after the adhering or after a period of time.

13. The detector according to claim 12, wherein said adhesive film is configured to be removed by forcibly pulling out an end of said adhesive film using tools or control methods.

14. The detector according to claim 13, wherein said removable double-faced adhesive film is adhered to four sides of said flat panel detector.

15. The detector according to claim 13, wherein said removable double-faced adhesive film is adhered to an entire surface of said flat panel detector.

16. The detector according to claim 15, wherein said removable double-faced adhesive film is arranged to diverge from a center of said flat panel detector to surroundings of said flat panel detector, and wherein said end of said adhesive film extends beyond said surface of said flat panel detector to facilitate removing said adhesive film by pulling said end.

17. The detector according to claim 16, wherein said removable double-faced adhesive film is in a strip spiral arrangement.

18. The detector according to claim 16, wherein said removable double-faced adhesive film is arranged such that said surface of said flat panel detector is divided into four triangular areas by two crossing diagonals, and wherein strips of said adhesive film connect end to end in succession in each area.

19. The detector according to claim 11, wherein said removable double-faced adhesive film comprises an optical adhesive film having a thickness of 100-200 microns.

20. A medical imaging diagnostic device comprising a detector, said detector comprising:
a flat panel detector;
a panel detector support; and
a removable double-faced adhesive film configured to bond said flat panel detector to said panel detector support.
